(19) United States
(12) Patent Application Publication
(10) Pub. No.: US 2026/0080150 A1
(43) Pub. Date: Mar. 19, 2026

(54) SYSTEM AND METHOD TO IMPROVE COMPRESSION OF TEXT CONTENT IN A COMPUTER SYSTEM

(71) Applicant: Jashna Oza, San Jose, CA (US)

(72) Inventor: Jashna Oza, San Jose, CA (US)

(21) Appl. No.: 18/885,662

(22) Filed: Sep. 15, 2024

(51) Int. Cl. G06F 40/126; G06F 40/166; G06F 40/263; G06F 40/279

(52) U.S. Cl. CPC G06F 40/126; G06F 40/166; G06F 40/263; G06F 40/279

(57) ABSTRACT

The embodiments herein provide a system and a method for improving compression efficiency of a text document. The method for improving compression efficiency of the text document includes identifying language of the text document and identifying longer words within the text document. The method further includes mapping the longer words to more shorter representations based on at least one of an international language pattern and a pre-defined compact form. Additionally, the method includes compacting the text document by substituting longer words with their corresponding shorter representations using a pre-defined look-up table. The method further includes applying conventional compression algorithms to compacted text document to achieve improved compression ratios.

### FIELD

This invention relates to a method and system for improving compression efficiency of a text document.

### BACKGROUND

The rapid advancement of digital technology and the exponential growth of information generated in the digital world have resulted in a massive increase in the volume of data stored in electronic devices. This surge is especially noticeable in text data, which plays a crucial role in a wide range of applications. These applications include everything from word processing and online communication to more advanced uses like training Machine Learning models such as Large Language Models (LLMs). However, the enormous volume of text data poses significant challenges in terms of storage and efficient data management. For addressing these issues, conventional compression algorithms are commonly used to reduce file sizes. Although these algorithms have been effective over the years, they still encounter limitations when handling large-scale text data, particularly in situations where storage optimization and transmission speed are crucial.

The current text compression techniques typically focus on minimizing redundancies within the data using methods like Huffman coding, Run-Length Encoding (RLE), and Lempel-Ziv-Welch (LZW) algorithms. These approaches compress data by detecting repeated patterns and optimizing storage accordingly. However, they do not exploit potential improvements that could be achieved by reducing the inherent length of the textual content before applying these techniques. Further, the current text compression techniques can be constrained by their inability to leverage cross-linguistic efficiencies. They compress data based on statistical patterns rather than semantic content, leading to suboptimal compression ratios, particularly in documents with significant non-repetitive content.

Thus, there is a need for a solution that complements traditional text compression techniques by tackling challenges such as low compression ratios, use of language-specific characteristics, and the inability to effectively process the growing volume of data, especially in the context of machine learning data.

### SUMMARY

The above-mentioned shortcomings, disadvantages and problems are addressed herein, which will be understood by reading and studying the following specification.

### BRIEF DESCRIPTION OF THE DRAWINGS

Embodiments herein are illustrated in the accompanying drawings, throughout which like reference letters indicate corresponding parts in the various figures. The example embodiments herein will be better understood from the following description with reference to the drawings, in which:

FIGS. 1 and 2 illustrate block diagrams showing a system for processing of text documents for enhancing compression efficiency, in accordance with an implementation of the present invention.

FIG. 3 illustrates a flowchart showing a method for processing of text documents for enhancing compression efficiency, in accordance with an implementation of the present disclosure.

### DETAILED DESCRIPTION

The embodiments herein and the various features and advantageous details thereof are explained more fully with reference to the non-limiting embodiments and detailed in the following description. Descriptions of well-known components and processing techniques are omitted so as not to unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Some embodiments of this disclosure, illustrating all its features, will now be discussed in detail. The words “enabling”, “establishing”, and other forms thereof, are intended to be open ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise. The terms “comprises,” “comprising,” “has,” “having,” “includes” and/or “including” as used herein, specify the presence of stated features, elements, and/or components and the like, but do not preclude the presence or addition of one or more other features, elements, components and/or combinations thereof. The term “an embodiment” is to be read as “at least one embodiment. ” The term “another embodiment” is to be read as “at least one other embodiment. ” Although any system and methods similar or equivalent to those described herein can be used in the practice or testing of embodiments of the present disclosure, the exemplary system and methods are now described.

The disclosed embodiments are merely examples of the disclosure, which may be embodied in various forms. Various modifications to the embodiment will be readily apparent to those skilled in the art and the generic principles herein may be applied to other embodiments. However, one of ordinary skill in the art will readily recognize that the present disclosure is not intended to be limited to the embodiments described but is to be accorded the widest scope consistent with the principles and features described herein.

The detailed description set forth below in connection with the appended drawings is intended as a description of various implementations of the present disclosure and is not intended to represent the only implementations in which details of the present disclosure may be applied. Each implementation described in this disclosure is provided merely as an example or illustration, and should not necessarily be construed as preferred or advantageous over other implementations.

There is a need for a system that addresses the challenges of the traditional compression techniques such as low compression ratios, use of language-specific characteristics, and the inability to effectively process the growing volume of data, especially in the context of machine learning data.

It must be understood that reference of any specific application in current disclosure, such as the processing of text documents, is merely provided for the ease of explanation, and should not be construed as a limiting factor for application of the methodologies described herein. Therefore, it is fairly possible for a person skilled in the art to utilize the details provided in current disclosure for any similar application.

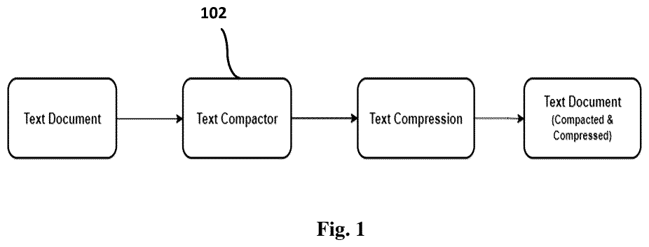

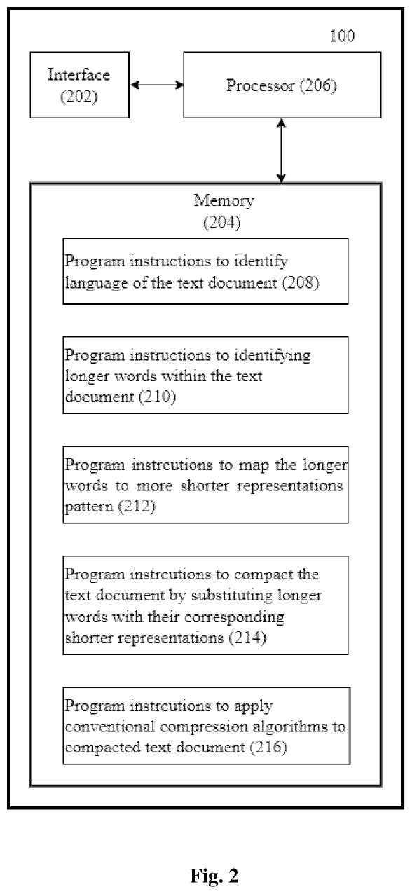

FIGS. 1 and 2 illustrate block diagrams showing different components of a system 100 for processing of text documents for enhancing compression efficiency, in accordance with an implementation of the present invention. The system 100 for processing of text documents for enhancing compression efficiency includes a memory 204, processor 206 and an interface 202. The system 100 may transmit and receive data through the interface 202. The memory 204 may store program instructions to identify language of a text document 208. Further, program instructions stored in the memory 204 may include program instructions to identify longer words within the text document 210, program instructions to map the longer words to more shorter representations based on at least one of an international language pattern and a pre-defined compact form 212, program instructions to compact the text document by substituting longer words with their corresponding shorter representations using a pre-defined look-up table 214 with the aid of a text compactor 102 and program instructions to apply conventional compression algorithms to compacted text document to achieve improved compression ratios 216.

In one embodiment, the system 100 for processing of text documents includes uncompacting of the text document by decompressing the text document using the commercial decompression algorithm and applying the pre-defined look-up table to restore the original text from the compacted shorter representations.

In yet another embodiment, the system 100 for processing text documents involves compacting the text document using the pre-defined look-up table, thereby reducing the text size and optimizing storage without the need for conventional compression algorithms.

In yet another embodiment, the system 100 for processing text documents involves compacting the text document using the pre-defined look-up table, which can be utilized without conventional compression algorithms to prepare the text for training machine learning technologies.

In another embodiment, the system 100 achieves higher compression ratio compared to text documents that are written in a single, uniform language due to the use of at least one of a multilingual and a language-agnostic pre-defined look-up table for compacting the text document.

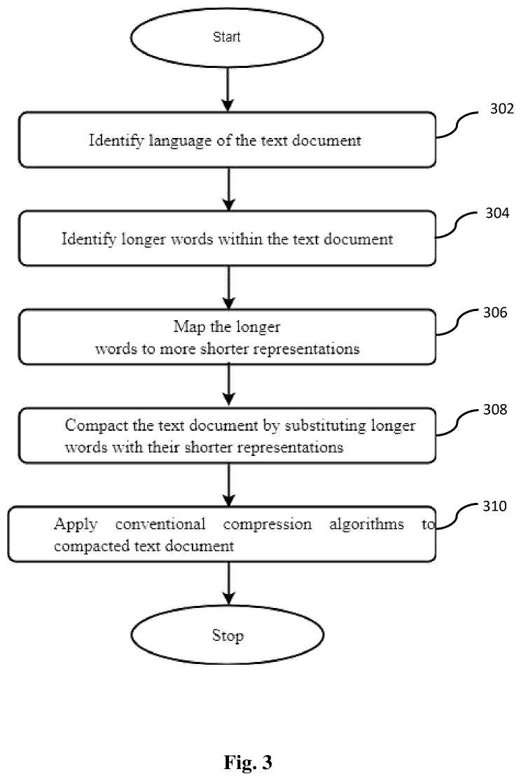

FIG. 3 illustrates a flowchart showing a method for processing of text documents for enhancing compression efficiency, in accordance with an implementation of the present disclosure. At step 302, language of the text document may be identified. At step 304, longer words within the text document may be identified. At step 306, the longer words may be mapped to more shorter representations based on at least one of an international language pattern and a pre-defined compact form. At step 308, the text document may be compacted by substituting longer words with their corresponding shorter representations using a pre-defined look-up table. At step 310, conventional compression algorithms may be applied to the compacted text document to achieve improved compression ratios.

In one embodiment, the method for processing of text documents includes uncompacting of the text document by decompressing the text document using the commercial decompression algorithm and applying the pre-defined look-up table to restore original text from compacted shorter representations.

In another embodiment, the method for processing of text documents includes compacting the text document using the pre-defined look-up table, thereby reducing the text size and optimizing storage without the need for conventional compression algorithms.

In yet another embodiment, the method for processing of text documents includes compacting the text document using the pre-defined look-up table, which can be utilized without conventional compression algorithms to prepare the text for training machine learning technologies.

In yet another embodiment, the method achieves higher compression ratio compared to text documents that are written in a single, uniform language due to the use of multilingual or language-agnostic pre-defined look-up table for compacting the

The method is illustrated in FIG. 3 as a collection of operations in a logical flow graph representing a sequence of operations that can be implemented in hardware, software, firmware or a combination thereof.

The present invention enhances the overall compression ratio, minimize storage requirements, and optimize data management processes.

The term “software” as used herein is intended to encompass such instructions stored in storage medium such as RAM, a hard disk, optical disk, cloud hosted, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on server or other location to perform certain functions.

An embodiment of the invention may be an article of manufacture in which a machine-readable medium (such as microelectronic memory) has stored thereon instructions which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

As used in the present specification, the term “artificial intelligence” refers broadly to an artificial intelligence technique in which a computer's behavior evolves based on empirical data. In some cases, input empirical data may come from databases and yield patterns or predictions thought to be features of the mechanism that generated the data. Further, a major focus of artificial intelligence is the design of algorithms that recognize complex patterns and makes intelligent decisions based on input data. Artificial Intelligence may incorporate a number of methods and techniques such as; supervised learning, unsupervised learning, reinforcement learning, multivariate analysis, case-based reasoning, backpropagation, and transduction.

A processor may include one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor), MIPS/ARM class processor, a microprocessor, a digital signal processor, an application specific integrated circuit, a microcontroller, a state machine, or any type of programmable logic array.

A memory may include but is not limited to, non-transitory machine-readable storage devices such as hard drives, magnetic tape, floppy diskettes, optical disks, Compact Disc Read-Only Memories (CD-ROMs), and magnetooptical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

Any combination of the above features and functionalities may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set as claimed in claims that issue from this application, in the specific form in which such claims issue, including any subsequent correction.

The terms “or” and “and/or” as used herein are to be interpreted as inclusive or meaning any one or any combination. Therefore, “A, B or C” or “A, B and/or C”mean “any of the following: A; B; C; A and B; A and C; B and C; A, B and C.” An exception to this definition will occur only when a combination of elements, functions, steps or acts are in some way inherently mutually exclusive.

In the above description, for purposes of explanation, numerous specific details are set forth in order to provide a thorough understanding of the present systems and methods. It will be apparent the systems and methods may be practiced without these specific details. Reference in the specification to “an example” or similar language means that a particular feature, structure, or characteristic described in connection with that example is included as described, but may not be included in other examples.

The foregoing description of the specific embodiments will so fully reveal the general nature of the embodiments herein that others can, by applying current knowledge, readily configure and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

I claim:

1. A method for processing of text documents for enhancing compression efficiency, comprising;
identifying language of the text document;
identifying longer words within the text document;
mapping the longer words to more shorter representations based on at least one of an international language pattern and a pre-defined compact form;
compacting the text document by substituting longer words with their corresponding shorter representations using a pre-defined look-up table; and
applying conventional compression algorithms to compacted text document to achieve improved compression ratios.

2. The method of claim 1, further comprising uncompacting of the text document by decompressing the text document using the commercial decompression algorithm and applying the pre-defined look-up table to restore original text from compacted shorter representations.

3. The method of claim 1, wherein the method for processing text documents involves compacting the text document using the pre-defined look-up table, thereby reducing the text size and optimizing storage without the need for conventional compression algorithms.

4. The method of claim 1, wherein the method for processing text documents involves compacting the text document using the pre-defined look-up table, which can be utilized without conventional compression algorithms to prepare the text for training machine learning technologies.

5. The method of claim 1, wherein the compression ratio is higher compared to text documents that are written in a single, uniform language due to the use of at least one of a multilingual and a language-agnostic pre-defined look-up table for compacting the text document.

6. A system for processing of text documents for enhancing compression efficiency, comprising:
one or more processors; and
one or more memories coupled with the one or more processors, the one or more memories storing programmed instructions, which when executed by the one or more processors, causes the one or more processors to:
identify language of a text document;
identify longer words within the text document;
map the longer words to more shorter representations based on at least one of an international language pattern and a pre-defined compact form;
compact the text document by substituting longer words with their corresponding shorter representations using a pre-defined look-up table; and
apply conventional compression algorithms to compacted text document to achieve improved compression ratios.

7. The system of claim 6, further comprising uncompacting of the text document by decompressing the text document using the commercial decompression algorithm and applying the pre-defined look-up table to restore the original text from the compacted shorter representations.

8. The system of claim 6, wherein the system for processing text documents involves compacting the text document using the pre-defined look-up table, thereby reducing the text size and optimizing storage without the need for conventional compression algorithms.

9. The system of claim 6, wherein the system for processing text documents involves compacting the text document using the pre-defined look-up table, which can be utilized without conventional compression algorithms to prepare the text for training machine learning technologies.

10. The system of claim 6, wherein the compression ratio is higher for text documents that are written in a single, uniform language due to the use of at least one of a multilingual and a language-agnostic pre-defined look-up table for compacting the text document.
